(19) United States
(12) Patent Application Publication
(10) Pub. No.: US 2008/0018451 A1
(43) Pub. Date: Jan. 24, 2008

(54) PASSENGER SCREENING SYSTEM AND METHOD

(76) Inventors: Jason Benfielt Slibeck, New York, CA (US); Daniel Mahlum, Pleasanton, CA (US); Stevan David Brill, New York, CA (US); Toder Petrov, Santee, CA (US); Brian Lon Ficke, San Diego, CA (US); Richard Shelby, San Diego, CA (US); Chirstopher W. Crowley, San Diego, CA (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/456,742

(22) Filed: Jul. 11, 2006

(51) Int. Cl. G08B 23/00; G08B 19/00; G08B 13/18

(52) U.S. Cl. 340/521; 340/573.1; 340/552

(57) ABSTRACT

A method of operating a passenger screening kiosk system includes operating the passenger screening kiosk system to perform a screening process that includes at least one of verify a passenger's identity, detect the presence of an explosive material, and detect the presence of a metallic material, generating a screening result, and associating the screening result with the passenger.

### BACKGROUND OF THE INVENTION

This invention relates generally to personnel screening systems utilized at passenger terminals, and more particularly, to a system configured to improve passenger handling in a transportation terminal and a method of operating the same.

The Transportation Security Administration (TSA) has recently mandated more stringent inspection procedures be implemented by the travel industry to reduce the possibility of passengers boarding a carrier such as a plane, for example, carrying concealed weapons, explosives, or other contraband. To facilitate preventing passengers boarding a plane carrying concealed weapons, explosives, etc., the TSA requires that all passengers be screened prior to boarding the aircraft.

For example, passengers arriving at the airport terminal first submit to a manual verification process that generally includes presenting their boarding pass and a form of identification such as a driver's license or passport, for example, to security personnel. The passenger then travels to a second security station where security personnel then manually verify that the passenger has a valid boarding pass, the name on the identification corresponds to the name on the boarding pass, and that the picture on the license or passport corresponds to the passenger presenting the license and boarding pass to the security personnel. After the manual verification process is completed, the passenger is requested to walk through a metal detector to ensure that the passenger is not carrying any concealed weapons.

While the current passenger screening process is reliable, the current process generally requires security personnel to be stationed at each screening station through which the passenger is processed to observe the results of the security process. As a result, the cost of implementing an effective security screening process at a transportation terminal is increased. Moreover, the time required to perform the screening process is increased thus necessitating passengers to arrive relatively early to allow the passenger sufficient time to complete the screening process.

### BRIEF DESCRIPTION OF THE INVENTION

In one aspect, a method of operating a passenger screening kiosk system is provided. The method includes operating the passenger screening kiosk system to perform a screening process that includes at least one of verify a passenger's identity, detect the presence of an explosive material, and detect the presence of a metallic material, generating a result of the screening process, and associating the screening result with the passenger.

In another aspect, a passenger screening system is provided. The system includes a kiosk with an identity verification system, a metal detection system, an explosives detection system, and a computer coupled to the identity verification system, the metal detection system, and the explosives detection system. The computer is configured to perform a screening process that includes at least one of verify a passenger's identity, detect the presence of an explosive material, and detect the presence of a metallic material, generate a result of the screening process, and associate the screening result with the passenger.

### BRIEF DESCRIPTION OF THE DRAWINGS

FIG. 1 is a right perspective view of an exemplary kiosk system;

FIG. 2 is a front view of the kiosk system shown in FIG. 1;

FIG. 3 is a side section view of the kiosk system shown in FIG. 1;

FIG. 4 is a simplified block diagram of an exemplary kiosk security system that includes a first modality and a second modality;

FIG. 5 is a schematic illustration of an exemplary Quadrupole Resonance (QR) screening system that may be utilized with the kiosk shown in FIGS. 1-4;

FIG. 6 is a right perspective view of the kiosk shown in FIGS. 1-3 including the screening system shown in FIG. 5;

FIG. 7 is a schematic illustration of a portion of the screening system shown in FIG. 6;

FIG. 8 is a schematic illustration of a portion of the screening system shown in FIG. 6; and

FIG. 9 is a flowchart illustrating an exemplary method of operating the screening system shown in FIGS. 1-8.

### DETAILED DESCRIPTION OF THE INVENTION

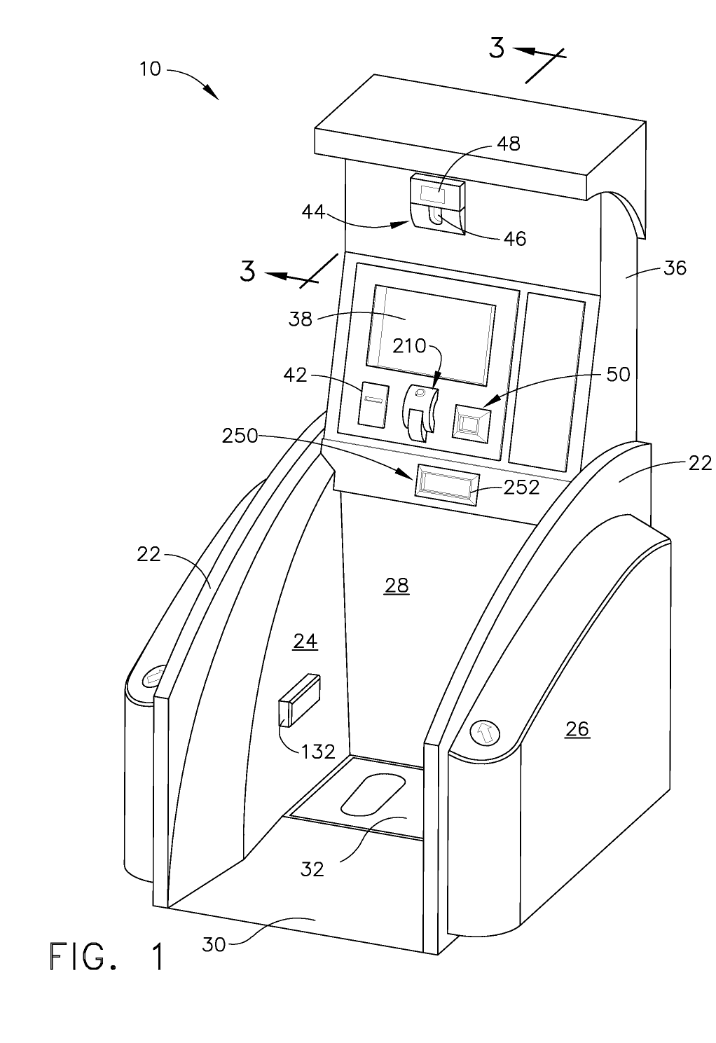

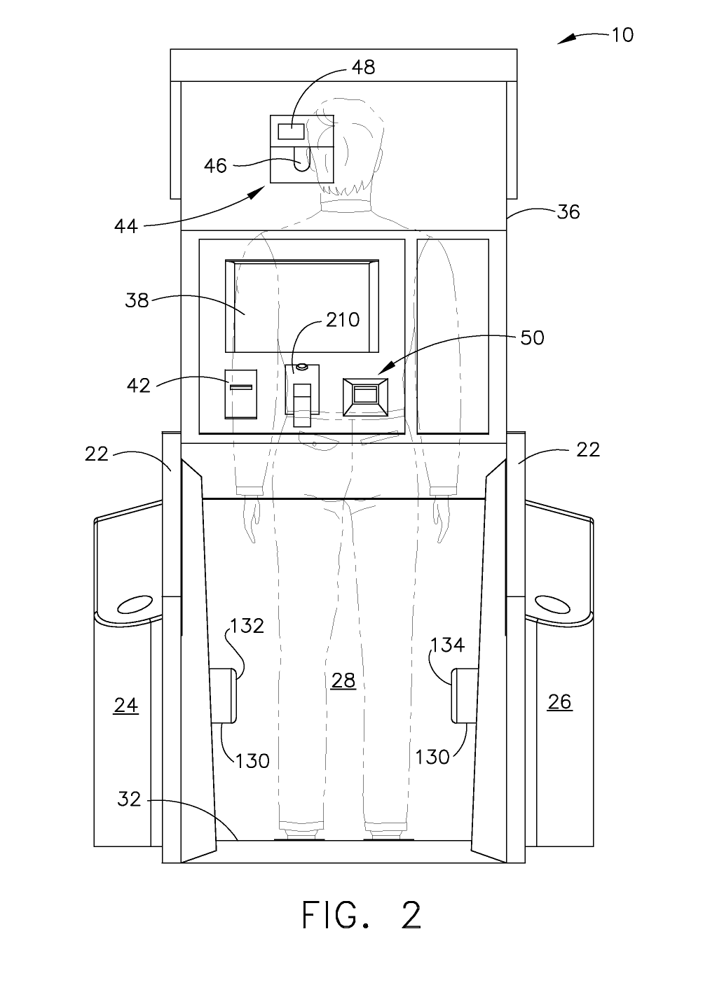

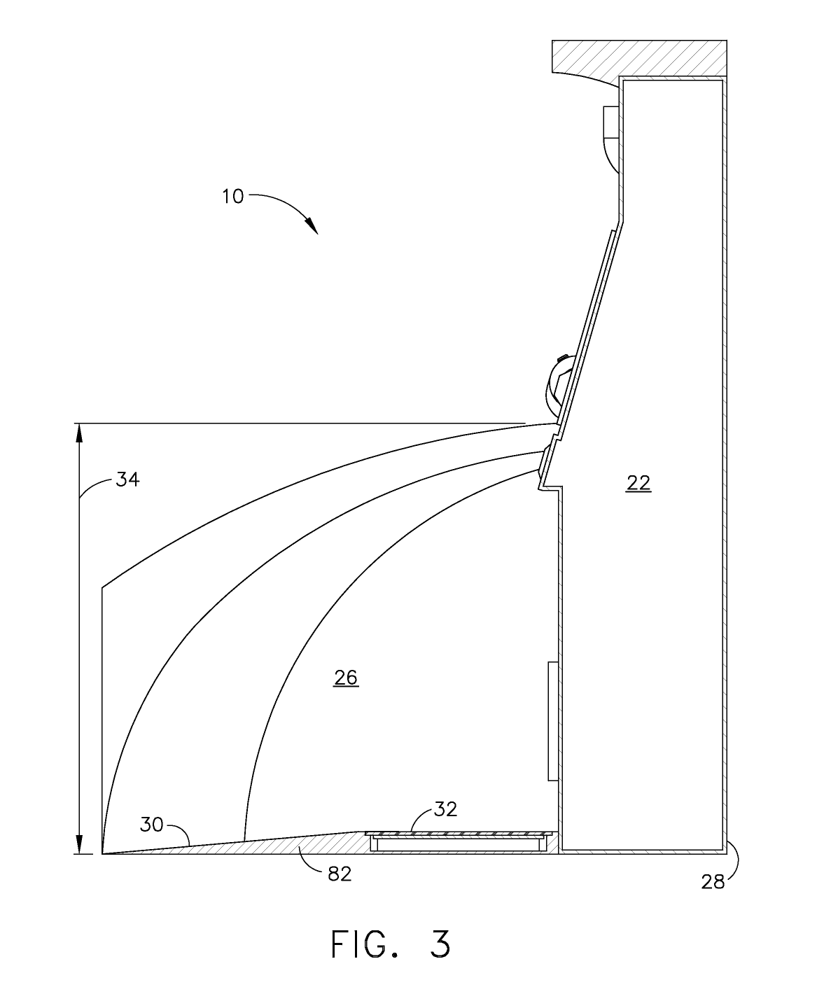

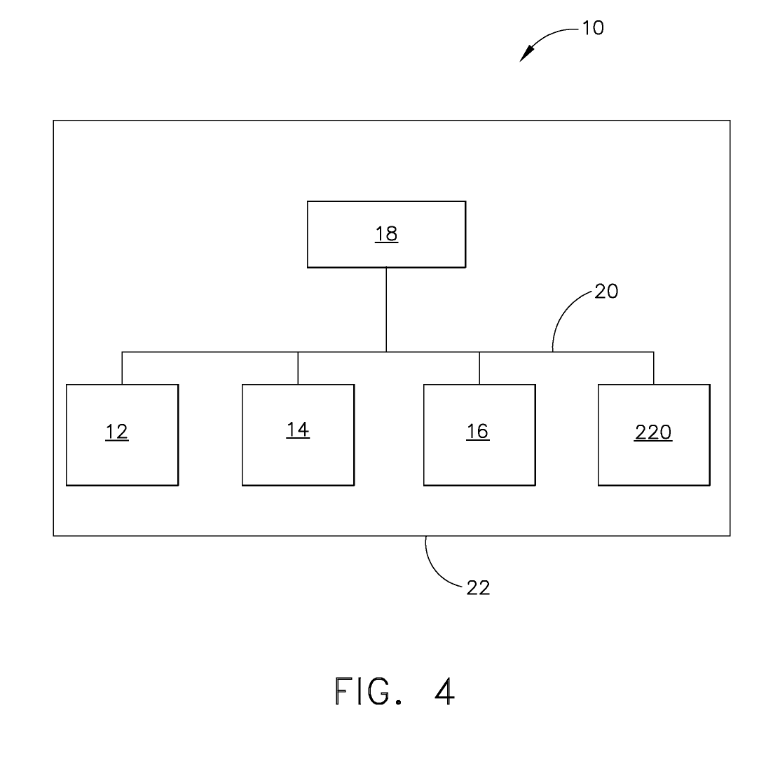

FIG. 1 is a right perspective view of an exemplary passenger screening system 10, FIG. 2 is a front view of the passenger screening system shown in FIG. 1, FIG. 3 is a side section view of the passenger screening system 10 shown in FIG. 1, and FIG. 4 is a simplified schematic illustration of the passenger screening system 10. As shown in FIG. 4, and in the exemplary embodiment, system 10 includes at least a first modality 12 referred to herein as passenger identification verification system 12, a second modality 14 referred to herein as passenger screening system 14, and a third modality 16 referred to herein as a metal detection system 16. System 10 also includes at least one computer 18, and a communications bus 20 that is coupled between modalities 12, 14, and 16, and computer 18 to enable operator commands to be sent to at least one of modalities 12, 14, and 16 and to allow outputs generated by modalities 12, 14, and 16 to be delivered to computer 18 and thus utilized by computer 18 for data analysis or utilized by an operator of computer 18. In one embodiment, modalities 12, 14, and 16 are hardwired to computer 18. In another embodiment, communications bus 20 is a local area network. Optionally, communications bus 20 includes an internet connection.

Modalities 12, 14, and 16 are integrated into a single screening system 10. In the exemplary embodiment, modalities 12, 14, and 16, and computer 18 are each housed within a single kiosk or housing 22. Optionally, computer 18 is housed separately from kiosk 22 and electrically coupled to modalities 12, 14, and 16 utilizing bus 20. As used herein, a kiosk is defined as a relatively small area that is at least partially enclosed by at least one wall. In the exemplary embodiment, the kiosk includes a forward wall that is coupled between a pair of walls to at least partially enclose the passenger screening area.

Referring again to FIGS. 1-3, kiosk 22 includes a first wall 24, a second wall 26 that is positioned substantially parallel to first wall 24, and a third wall 28 that is positioned substantially perpendicular to and coupled between first and second walls 24 and 26, respectively. Kiosk 22 also includes a floor 30 extending between first, second, and third walls 24, 26, and 28, that, in one exemplary embodiment, includes an inductive sensor unit 32 that is described in further detail below. For example, and as shown in FIGS. 1 and 2, the three walls, 24, 26, and 28 define a single opening such that a passenger may enter and exit kiosk 22 through the same opening. Optionally, kiosk 22 may include two walls 24 and 26 such that the passenger may enter kiosk 22 through a first opening, traverse through kiosk 22, and exit kiosk 22 through a second opening.

In one embodiment, the kiosk walls each have a height 34 of between approximately 28-42 inches. The embodiments of FIGS. 1, 2, and 3 show the left and right walls 24 and 26 formed with an approximate arcuate shape having a radius which approximates the height of the walls. Note that walls 24 and 26 have been optionally truncated at the entrance. Truncating walls 24 and 26 facilitates the movement of people into and out of system 10, and further extends the notion of openness of the screening system. Optionally, kiosk walls 24 and 26 have a height 34 that is greater than a height of a typical passenger, i.e. like a phone booth for example, such that the entire passenger's body may be screened.

In the exemplary embodiment, kiosk 22 also includes a control panel section 36 that is coupled to forward wall 28 and extends upwardly from forward wall 28 to a predetermined height to facilitate providing various operator controls. Control panel section 36 also includes a monitoring or display device 38 that may be utilized to prompt a passenger to either input selected information into the screening system and/or prompt a passenger to perform various actions within the screening system to facilitate the system to expediently verify the passenger's identity and inspect the passenger for contraband as will be described later herein.

In the exemplary embodiment, to facilitate verifying a passenger's identity, system 10 includes a electronic card reader 42 wherein a passenger enters a registration card into a receptacle provided with kiosk 22. In the exemplary embodiment, the passenger registration card includes biometric information of the passenger that has been encoded onto the registration card obtained by the passenger during a prescreening process. For example, a passenger may obtain a registration card by registering with the Registered Traveler Program wherein a passenger is pre-screened by the TSA or some other authorized screening entity, to obtain biometric information that is then stored on the passenger's registration card. The biometric information may include the passengers fingerprints, iris scan information, hand print information, voice recognition information, or other suitable biometric information. The information on the registration may be encoded on a magnetic strip, use optical read codes, use an RF-read memory chip, or other embedded media.

Accordingly, during operation, the passenger inserts their registration card into electronic card reader 42. Passenger identify verification system 12 then prompts the passenger to position a selected body part on a sensor that is utilized to collect biometric information from the passenger within kiosk 22. The collected information is then compared to the biometric information stored on the registration card to verify the identity of the passenger.

In one exemplary embodiment, passenger identity verification system 12 may be implemented utilizing a iris scan device 44 to generate biometric information that is then compared to the information on the Registered Traveler's registration card in order to verify that the passenger being screened is the passenger to whom the card in fact belongs. In the exemplary embodiment, iris scan device 44 includes an illuminating device 46 that directs light having desired characteristics to the eye under observation such that at least one of the iris and/or pupil of the eye under observation take a characteristic shape. The exemplary iris scan device 44 also includes a light imaging apparatus 48 to generate an image of the iris and/or pupil. The generated image is then compared to information that is stored on the registration card. It should be realized that in the exemplary embodiment, the generated image described herein are computer generated images or data files of an image that are stored within the computer and not physical images. Specifically, the systems described herein generate an electronic image or datafile that is compared to an electronic image or datafile stored on the registration card or optionally within system 10 to verify the identity of the passenger.

In another exemplary embodiment, passenger identity verification system 12 may be implemented utilizing a fingerprint scan device 50 wherein a passenger places a finger on the fingerprint scan device 50 such that the device obtains an image of the fingerprint of the passenger being verified. The generated image is then compared to information that is stored on the registration card or optionally, information stored on computer 18. It should be realized that in the exemplary embodiment, the generated image described herein are computer generated images or data files of an image that are stored within the computer and not physical images. Specifically, the system described herein generate an electronic image or datafile that is compared to an electronic image or datafile stored on the registration card or optionally within system 10 to verify the identity of the passenger. Optionally, the passenger identity verification system 12 may be implemented utilizing a hand scanning device, a facial image recognition system and/or a voice recognition system in order to verify the identity of the passenger.

As described above, passenger identity verification system 12 generally requires a passenger to be prescreened or have a pre-existing, authenticated identification in order to facilitate verifying the identity of the passenger. For example, passengers may participate in a prescreening program whereby an initial, relatively thorough, screening of the passenger is conducted to generate information about the passenger that may be utilized by system 10 at a later date. As such, the passenger may choose to have a fingerprint scan completed, an iris scan, a hand scan, a voice scan, and/or a facial recognition scan completed. The information collected during the prescreening procedure is then stored on the registration card, such that when a passenger enters kiosk 22, the information stored on the registration card may be may be compared to the information generated by one of the identity screening systems within kiosk 22 to facilitate verifying the passenger's identity and thus reduce the amount of time to complete passenger screening and thus improve the convenience of passenger screening. Moreover, prescreening facilitates shifting limited security resources from lower-risk passengers to passengers that have not been prescreened.

In the exemplary embodiment, passenger screening system 14 may be implemented using a quadrupole resonance (QR) detection system that utilizes quadrupole resonance to detect explosives such as, but not limited to C4, Semtex, Detasheet, TNT, ANFO, and/or HMX since the quadrupole resonance signature of these explosives is unique and measurable in seconds.

Nuclear Quadrupole Resonance (NQR) is a branch of radio frequency spectroscopy that exploits the inherent electrical properties of atomic nuclei and may therefore be utilized to detect a wide variety of potentially explosive materials. For example, nuclei having non-spherical electric charge distributions possess electric quadrupole moments. Quadrupole resonance arises from the interaction of the nuclear quadrupole moment of the nucleus with the local applied electrical field gradients produced by the surrounding atomic environment. Any chemical element's nucleus which has a spin quantum number greater than one half can exhibit quadrupole resonance. Such quadrupolar nuclei include: ⁷Li, ⁹Be, ¹⁴N, ¹⁷O, ²³Na, ²⁷Al, ³⁵Cl, ³⁷Cl, ³⁹K, ⁵⁵Mn, ⁷⁵As, ⁷⁹Br, ⁸¹Br, ¹²⁷I, ¹⁹⁷Au, and ²⁰⁹Bi. Many substances containing such nuclei, approximately 10,000, have been identified that exhibit quadrupole resonance.

It so happens that some of these quadrupolar nuclei are present in explosive and narcotic materials, among them being ¹⁴N, ¹⁷O, ²³Na, ³⁵Cl, ³⁷Cl, and ³⁹K. The most studied quadrupolar nucleus for explosives and narcotics detection is nitrogen. In solid materials, electrons and atomic nuclei produce electric field gradients. These gradients modify the energy levels of any quadrupolar nuclei, and hence their characteristic transition frequencies. Measurements of these frequencies or relaxation time constants, or both, can indicate not only which nuclei are present but also their chemical environment, or, equivalently, the chemical substance of which they are part.

When an atomic quadrupolar nucleus is within an electric field gradient, variations in the local field associated with the field gradient affect different parts of the nucleus in different ways. The combined forces of these fields cause the quadrupole to experience a torque, which causes it to precess about the electric field gradient. Precessional motion generates an oscillating nuclear magnetic moment. An externally applied radio frequency (RF) magnetic field in phase with the quadrupole's precessional frequency can tip the orientation of the nucleus momentarily. The energy levels are briefly not in equilibrium, and immediately begin to return to equilibrium. As the nuclei return, they produce an RF signal, known as the free induction decay (FID). A pick-up coil detects the signal, which is subsequently amplified by a sensitive receiver to measure its characteristics.

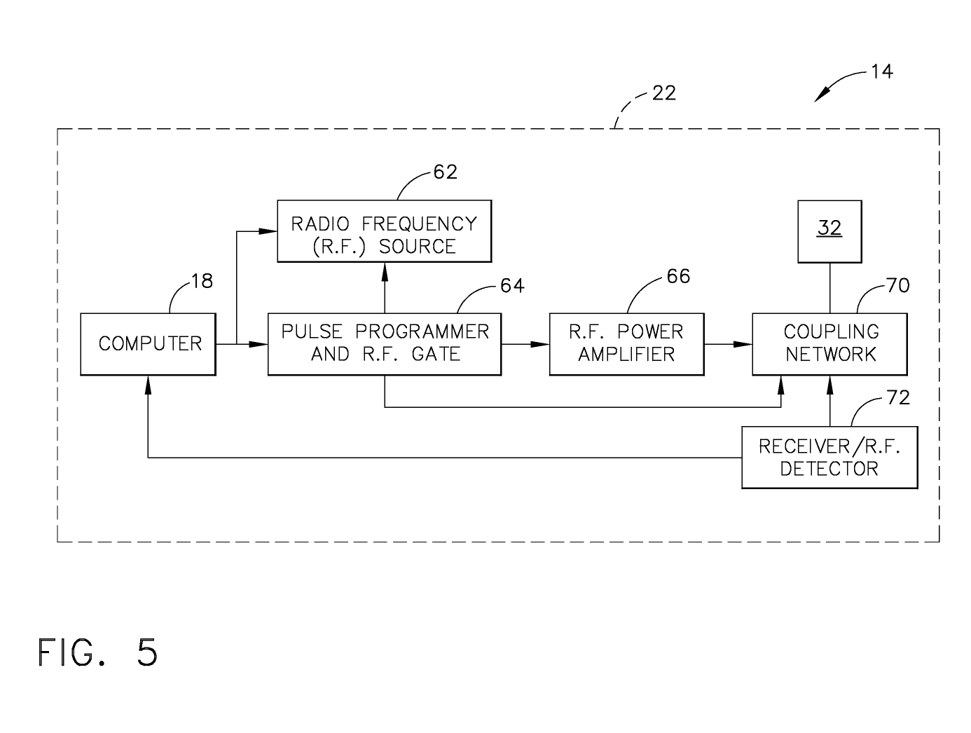

FIG. 5 is a simplified schematic illustration of an exemplary quadrupole resonance system 14 that includes a radio frequency source 62, a pulse programmer and RF gate 64 and an RF power amplifier 66 that are configured to generate a plurality of radio frequency pulses having a predetermined frequency to be applied to a coil such as sensor 32 (also shown in FIGS. 1-3). A communications network 70 conveys the radio frequency pulses from radio frequency source 62, pulse programmer and RF gate 64 and RF power amplifier 66 to sensor 32 that, in the exemplary embodiment, is positioned within kiosk 22. The communications network 70 also conducts the signal to a receiver/RF detector 72 from sensor 32 after the passenger is irradiated with the radio frequency pulses.

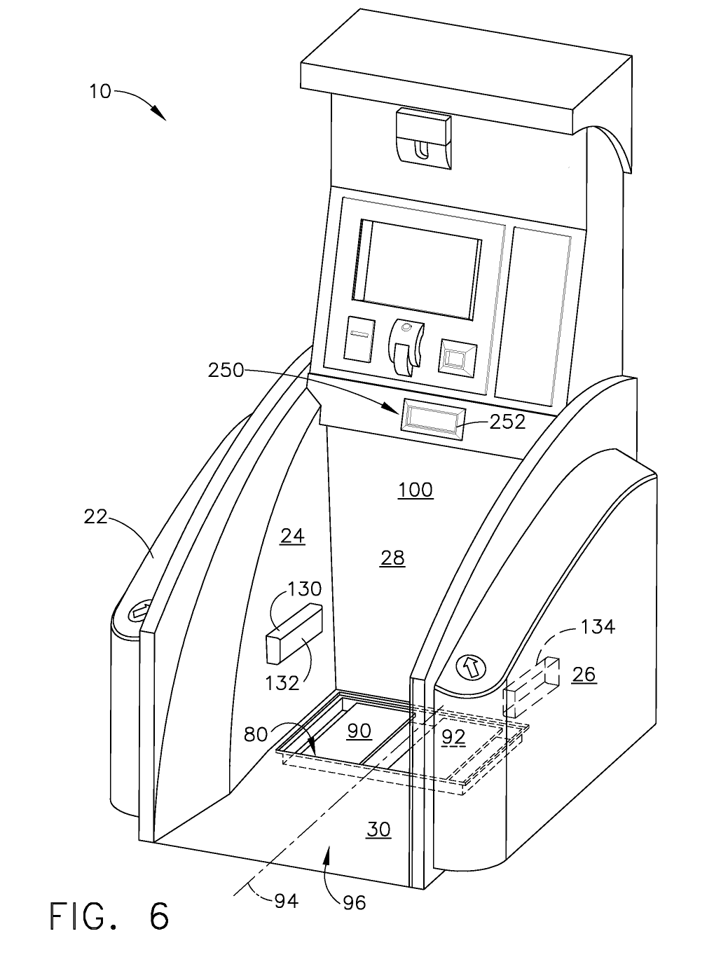

FIG. 6 is a right perspective view of kiosk 22 including quadrupole resonance (QR) detection system. As stated above, quadrupole resonance (QR) detection system 14 includes an inductive sensor 32 that in the exemplary embodiment, is positioned proximate third wall 28 approximately between first and second walls 24 and 26. In accordance with this embodiment, inductive sensor 32 may be positioned within a recessed region 80 of floor 30, between an entrance ramp 82 and third wall 28. This recessed region 80 may also be referred to as the sensor housing. In FIG. 6, the inductive sensor 32 has been omitted to show sensor housing 80, which is recessed within floor 30.

As shown in FIG. 6, and in the exemplary embodiment, inductive sensor 32 may be implemented using two anti-symmetric current branches 90 and 92 that may be located on opposing sides of a medial plane 94. Specifically, current branch 90 is positioned on one side of medial plane 94, while current branch 92 is positioned on the opposite side of medial plane 94.

Inductive sensor 32 may be configured in such a manner that both current branches 90 and 92 experience current flow that is generally or substantially parallel to the left and right walls 24 and 26. For example, the current branches 90 and 92 may be placed in communication with an electrical source (not shown in this figure). During operation, current flows through current branch 90 in one direction, while current flows through current branch 92 in substantially the opposite direction. The term “anti-symmetric current flow” may be used to refer to the condition in which current flows through the current branches in substantially opposite directions.

In the exemplary embodiment, inductive sensor 32 is implemented using a quadrupole resonance (QR) sensor. For convenience only, various embodiments will be described with reference to the inductive sensor implemented as a QR sensor 32, but such description is equally applicable to other types of inductive sensors.

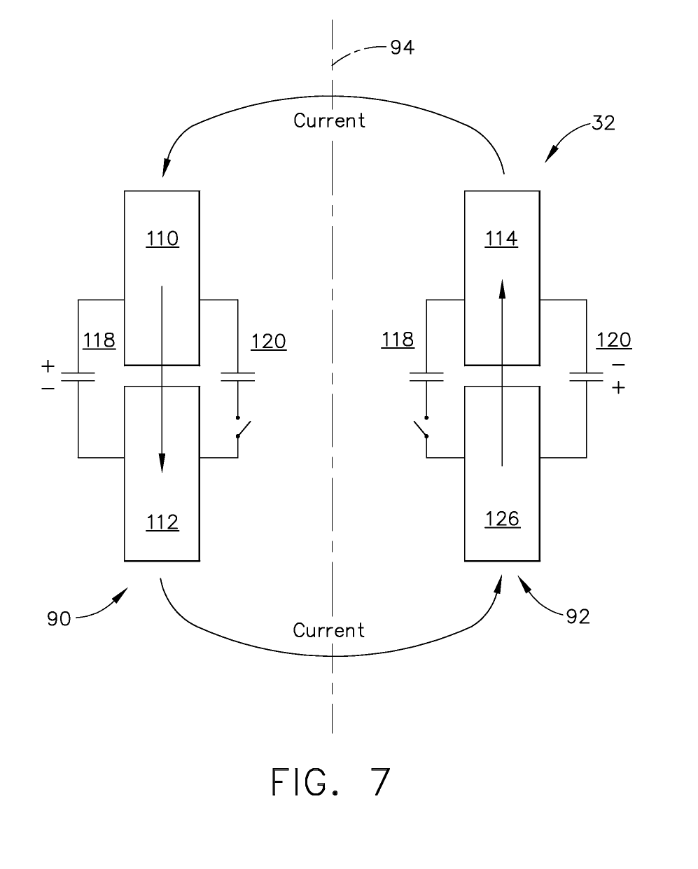

In the exemplary embodiment, current branches 90 and 92 collectively define a QR sheet coil that is shown as sensor 32 in FIG. 7. For convenience only, further discussion of the QR sensor will primarily reference a “QR sheet coil,” or simply a “QR coil”. During a typical screening process, a passenger enters the system at an entrance 96, and then stands within an screening region defined by QR sensor 32. Specifically, the passenger may stand with their left foot positioned relative to current branch 90 and their right foot positioned relative to current branch 92. The QR sensor then performs an screening process using nuclear quadrupole resonance (NQR) to detect the presence of a target substance associated with the passenger.

As shown in FIG. 5, QR sensor 32 is in communication with the RF subsystem, defined generally herein to include radio frequency source 62, pulse programmer and RF gate 64, and RF power amplifier 66 which provides electrical excitation signals to current branches 90 and 92. The RF subsystem may utilize a variable frequency RF source to provide RF excitation signals at a frequency generally corresponding to a predetermined, characteristic NQR frequency of a target substance. During the screening process, the RF excitation signals generated by the RF source may be introduced to the specimen, which may include the shoes, socks, and clothing present on the lower extremities of a passenger standing or otherwise positioned relative to the QR sensor 32. In the exemplary embodiment, the QR coil 32 also functions as a pickup coil for NQR signals generated by the specimen, thus providing an NQR output signal which may be sampled to determine the presence of a target substance, such as an explosive, utilizing computer 18, for example.

In the exemplary embodiment, QR sensor 32 utilizes an EMI/RFI (electromagnetic interference/radio frequency interference) shield to facilitate shielding sensor 32 from external noise, interference and/or to facilitate inhibiting RFI from escaping from the screening system during an screening process. In the exemplary embodiment, walls 24, 26, and 28 are configured to perform RF shielding for QR sensor 32. Specifically, walls 24, 26, and 28 are electrically connected to each other, to entrance ramp 82, and to sensor housing 80 to form an RF shield 100.

Each of the shielding components, i.e. walls 24, 26, and 28 may be fabricated from a suitably conductive material such as aluminum or copper. Typically, the floor components, i.e. ramp 82 and sensor housing 80 are welded together to form a unitary structure. Additionally, walls 24, 26, and 28 may also be welded to the floor components, or secured using suitable fasteners such as bolts, rivets, and/or pins. QR sensor 32 may be secured within sensor housing 80 using, for example, any of the just-mentioned fastening techniques. If desired, walls 24, 26, and 28, entrance ramp 82, and the QR sensor 32 may be covered with non-conductive materials such as wood, plastic, fabric, fiberglass, and the like.

FIG. 7 is a simplified schematic illustration of the exemplary QR sensor 32 shown in FIG. 6. Left current branch 90 is shown having upper and lower conductive elements 110 and 112, which are separated by a non-conductive region. Similarly, right current branch 92 includes upper and lower conductive elements 114 and 116, which are also separated by a non-conductive region. The left and right current branches 90 and 92 collectively define the QR coil of sensor 32, and may be formed from any suitably conductive materials such as copper or aluminum, for example.

No particular length or width for the current branches 90 and 92 is required. In general, each current branch may be dimensioned so that it is slightly larger than the object or specimen being inspected. Generally, current branches 90 and 92 are sized such that a passenger's left foot and right foot (with or without shoes) may be respectively placed in close proximity to the left and right current branches 90 and 92. This may be accomplished by the passenger standing over the left and right current branches. In this scenario, the left and right branches may each have a width of about 4-8 inches and a length of about 12-24 inches. It is to be understood that the terms “left” and “right” are merely used for expositive convenience and are not definitive of particular sides of the structure.

Upper and lower conductive elements 110 and 112 are shown electrically coupled by fixed-valued resonance capacitor 118 and tuning capacitor 120, which is a switched capacitor that is used to vary tuning capacitance. Upper and lower conductive elements 114 and 116 may be similarly configured.

FIG. 7 also includes several arrows which show the direction of current flow through the left and right current branches 90 and 92 which in the exemplary embodiment, is in a counter-clockwise direction. During operation, current flows through left current branch 90 in one direction, while current flows through right current branch 92 in substantially the opposite direction. The reason that current flows through the two current branches in opposite directions is because the left and right current branches 90 and 92 each have a different arrangement of positive and negative conductive elements. For instance, left current branch 90 includes a positive upper conductive element 110 and a negative lower conductive element 112. In contrast, right current branch 92 includes a negative upper conductive element 114 and a positive lower conductive element 116. This arrangement is one example of a QR sensor providing counter-directed or anti-symmetric current flow through the current branches.

In accordance with the exemplary embodiment, current flows between the left and right current branches 90 and 92 during operation since these components are electrically coupled via ramp 82 and the sensor housing 80. During operation, a passenger may place their left foot over left current branch 90 and their right foot over right current branch 92. In such a scenario, current is directed oppositely through each branch resulting in current flowing from toe to heel along left current branch 90, and from heel to toe along right current branch 92. In the exemplary embodiment, QR sensor 32 is positioned within sensor housing 80 to form a non-conductive gap between current branches of the QR sensor. This gap allows the magnetic fields to circulate about their respective current branches.

In contrast to conventional inductive sensor systems, the counter-directed magnetic fields generated by QR sensor 32 are well-attenuated and have a topography that is especially suited for use with a kiosk that includes a first wall 24, a second wall 26 that is opposite to first wall 24, and a third wall 28 that is substantially perpendicular to first and second walls 24 and 26, and a floor 30 that is connected to first wall 24, second wall 26, and third wall 28.

As an example of a practical application, the left and right current branches 90 and 92 may be positioned about 2-7 inches from respective walls 24, 26, and 28 using a plurality of non-conductive regions. In addition, current branches 90 and 92 may be positioned about 4-14 inches from each other using a non-conductive region.

Passenger screening system 14 may also be implemented using a fingertip trace explosive detection system 210 (shown in FIGS. 1 and 2). Fingertip trace explosive detection system 210 is capable of detecting minute particles of interest such as traces of narcotics, explosives, and other contraband on the passenger's finger or hand for example. In the exemplary embodiment, the passenger is prompted to press a button to activate fingertip trace explosive detection system 210 such that trace materials on the finger surface are collected and then analyzed by fingertip trace explosive detection system 210. As such, fingertip trace explosive detection system 10 is configured to determine when a passenger's finger has been placed over the device to activate the fingertip trace explosive screening procedure.

In the exemplary embodiment, fingertip trace explosive detection system 210 includes an ion trap mobility spectrometer (not shown) that is utilized to determine whether any substantially minute particles of interest such as traces of narcotics, explosives, and other contraband is found on the passenger's finger. For example, the ion trap mobility spectrometer is preferentially useful in identifying trace explosives or other contraband on a passenger's finger that may be indicative of the passenger recently manipulating explosives or other contraband and as such does not require imaging or localization.

In the exemplary embodiment, and referring again to FIGS. 1 and 2, modality 16, i.e. the metal detection system 16 may be implemented utilizing a pair metal detection coils 130 that are utilized in conjunction with inductive sensor 32. Each of the metal detection coils 130 may be configured to detect conductive objects present within the vicinity of the lower extremities of the inspected passenger. These signals may be communicated to a suitable computing device for example computer 18. More specifically, and as shown in FIG. 6, modality 16 includes a first metal detection coil 132 and a second metal detection coil 134 that are each mounted to a side of kiosk 22.

Specifically, first metal detection coil 132 is mounted to an inner surface of first wall 24 and second metal detection coil 134 is mounted to an inner surface of second wall 26. In the exemplary embodiment, metal detection coils 132 and 134 are each mounted at a height above floor 30 to is most advantageous to conduct a metal detection screening of the lower extremities of the passenger. For example, coils 132 and 134 may be positioned approximately 12-40 inches above floor 30. In the exemplary embodiment, metal detection coils 132 and 134 are inductive coils such that when a first current flows through the first metal detection coil 132 in a first direction a first magnetic field is formed, and when the current flows through the second metal detection coil, in a second opposite direction, a second magnetic field is formed.

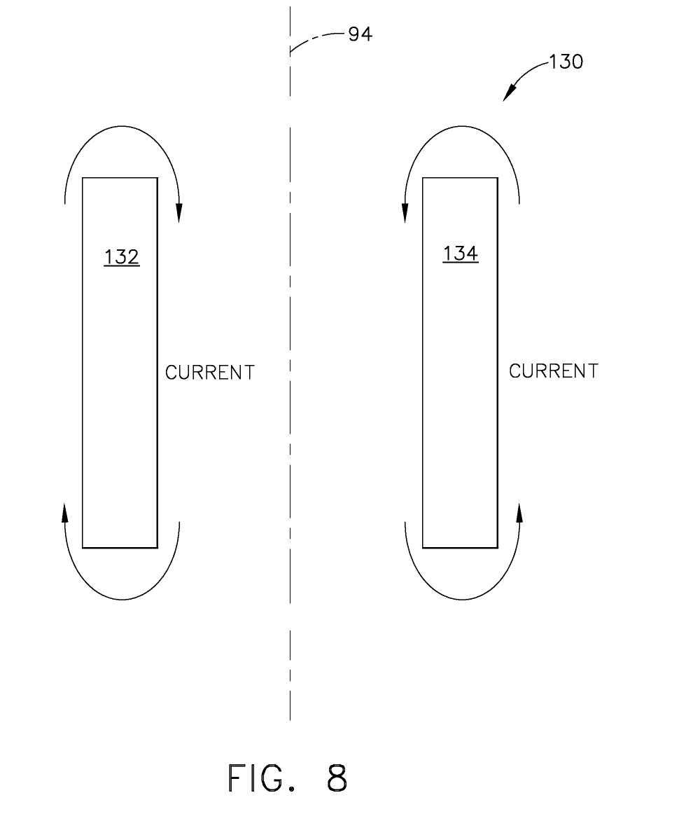

FIG. 8 is a simplified schematic illustration of the metal detection coils 132 and 134 shown in FIG. 6. Metal detection coil 132 and metal detection coil 134 are each separated by a non-conductive region 136 which generally is the utilized for the passenger, i.e. the passenger is positioned between coils 132 and 134 to facilitate operation of the system. Coils 132 and 134 may be formed from any suitably conductive materials such as copper or aluminum, for example, and no particular length or width for the sensors 132 and 134 is required. In general, each coil is dimensioned so that it is slightly larger than the object or specimen being inspected. It is to be understood that the terms “left” and “right” are merely used for expositive convenience and are not definitive of particular sides of the structure.

FIG. 8 also includes several arrows which show the direction of current flow through the left and right coils 132 and 134 which in the exemplary embodiment, is in a clockwise direction through coil 132 and in a counterclockwise direction through coil 134 such that the current flow through the pair of coils 130 is anti-symmetric to the flow of current through sensor 32 (shown in FIG. 7), and such that there is no mutual inductance between coil pair 130 and sensor 32.

More specifically, current is supplied to coils 132 and 134 utilizing a line driver circuit or a signal driver, for example, such that each coil 132 and 134 generates a magnetic field around each respective coil. In the exemplary embodiment, the QR sensors 32 are utilized to monitor or detect any changes in the magnetic field generated by coils 132 and 134. More specifically, when no metallic object is positioned between coils 132 and 134, the coils are substantially balanced. That is, a balanced or null signal is injected into the QR sensors 32 such that QR sensors 32 do not detect any imbalance between coils 132 and 134. However, if a passenger, carrying a metallic object is positioned between coils 132 and 134, the signals generated by coils 132 and 134 will become unbalanced, i.e. a signal having some amplitude, will be detected by QR sensor 32. Accordingly, when system 10 is configured to operate modality 14, i.e. the metal detection modality, QR sensors 32 are electromagnetically the QR driver circuit to enable the QR sensors 32 to detect any disturbances in the magnetic field generated by coils 132 and 134.

In the exemplary, embodiment, metal detection coils 132 and 134 are each calibrated to ensure that they are substantially in balance, i.e. produce a magnetic field of similar strength, when no metallic object is positioned between them. Moreover, QR sensor 32 is calibrated to identify and changes in the magnetic field generated by coils 132 and 134. As such, and in the exemplary embodiment, QR sensor 32 is utilized to detect any changes in the magnetic fields generated by coils 132 and 134. In the exemplary embodiment, when the QR sensors detects a change in the magnetic fields generated by coils 132 and 134 has exceeded a predetermined threshold, an alarm or other indication will be enabled to prompt an operator that a metallic object has been detected and further, more detailed screening of the passenger may be required.

Although the exemplary metal detection system 16 described herein is generally is directed toward scanning the lower region of the passenger while the passenger is still wearing shoes, it should be realized that system 16 may be implemented to scan the entire passenger with or without the passenger wearing shoes.

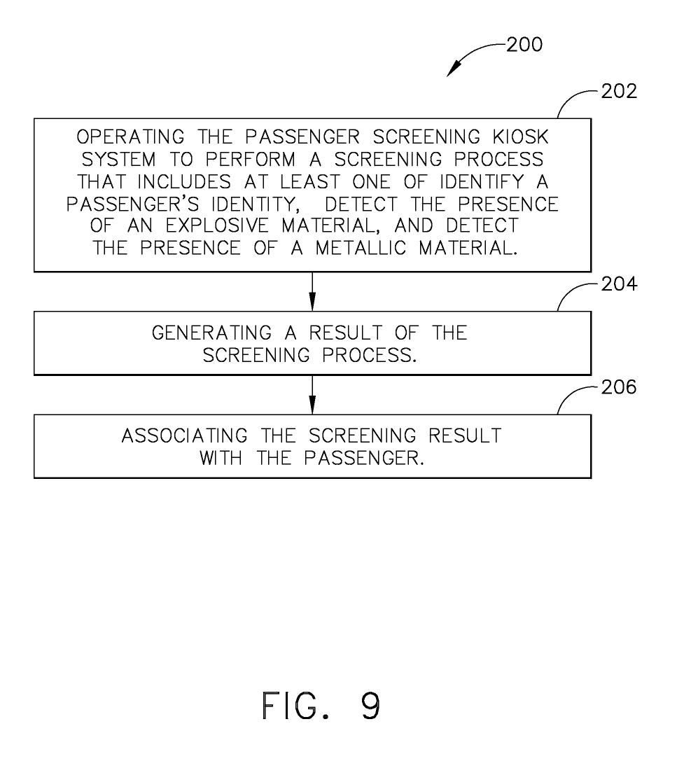

FIG. 9 is a flow diagram of an exemplary method 200 of operating screening system 10 to verify the identify of a passenger and detect the presence of at least one of an explosive material and a metallic material. Method 200 includes operating 202 the passenger screening kiosk system to perform a screening process that includes at least one of verify a passenger's identity, detect the presence of an explosive material, and detect the presence of a metallic material, generating 204 a result of the screening process, and associating 206 the screening result with the passenger.

Specifically, as described above, kiosk 22 includes a first modality utilized to perform explosives and or drug detection, a second modality utilized to perform metal detection, and a third modality utilized to verify the identity of the passenger within the kiosk. As such, after system 10 has determined that a passenger to be inspected is within kiosk 22, system 10 in one embodiment, prompts the passenger to enter identity information. For example, as described above, kiosk 22 requests a passenger to enter a registration card having the passenger's previously verified biometric information into the electronic card reader 42. System 10 then automatically prompts the passenger to place a body part onto one of the identity verification systems. In one example embodiment, system 10 prompts the passenger to place at least one eye in front of the iris scan device 44. System 10 then determines whether the passenger's eye is positioned in front of the iris scan device 44 and automatically initiates scanning the passenger's eye to produce an image of the iris as described above. The generated image is then compared to the biometric information stored on the passenger's registration card to verify the identity of the passenger.

In another embodiment, system 10 automatically prompts the passenger to place a finger on the fingerprint scan device 50. System 10 then determines whether the passenger's finger is positioned on the fingerprint scan device 50 and automatically initiates scanning the passenger's finger to produce an image of the iris as described above. The generated image is then compared to the biometric information stored on the passenger's registration card to verify the identity of the passenger.

After the identity of the passenger has been determined, system 10 then prompts a passenger to perform an explosives detection search. In one embodiment, system 10 prompts the passenger to press their thumb on the fingertip trace explosive detection system 210. In the exemplary embodiment, system 210 is configured to determined whether the passenger's finger is positioned on system 21-and automatically initiate a trace explosives scan on the fingertip of the passenger within kiosk 22 in a relatively short time period, thus decreasing the time required to inspect a passenger for explosives.

After, system 10 has verified the passenger's identity and performed the screening process 202 to detect both metal and explosive materials which may be concealed on the passenger's body, system 10 is configured to generate 204 a result of the screening process, and associate 206 the screening result with the passenger.

Generating a screening result includes storing the passenger's identity within computer 18, generating a threat level indication based on the result of the screening process, and associating the threat level indication with the passenger's identity. As described above, system 10 is utilized to verify the passenger's identity and store the results of the verification, e.g. the identity is either verified or not verified, within a computer database within computer 10, for example,

A threat level indication is then generated and stored in the database. In the exemplary embodiment, threat level indication as used herein is defined as an indication of the threat level assigned to the passenger based on the results of the metal and explosives screening process. The threat level indication may include a clearance indication, an identity alert indication, a threat alert indication, and/or an alarm indication.

If the passenger's identity is verified and no threats are detected, for example, a threat level indication “clearance” is generated. If the passenger's identity is not verified, but no threats are detected, a threat level indication “identity alert” is generated. If the passenger's identity is verified, but a (potential) threat is detected, a threat level indication “threat alert” is generated. Moreover, if the passenger's identity is not verified, and a (potential) threat is detected, a threat level indication “alarm” is generated. Depending on the result, different procedures are implemented for the passenger's subsequent traversal of the station. For example, after a clearance, the passenger may not need to divest their shoes, coats or jackets when passing through the typical metal detector portal. At the same time, the portal's sensing zone nearest the floor (usually called “zone zero”) can be desensitized so that it doesn't alarm on benign metallic shoe shanks, toe guards, or decorations. Thus, being cleared by the kiosk can significantly speed up the subsequent security station traversal, both benefiting that passenger and increasing throughput, indirectly benefiting all passengers as well as the station staff.

After the security screening process is completed, system 10 includes an associating device 250 (shown in FIG. 1) that is configured to associate the screening result with the passenger. In the exemplary embodiment, associating device 250 may be implemented utilizing a printing device 252 (shown in FIG. 1) installed in kiosk 22.

Specifically, as described above, the screening result, i.e., the threat level indication is stored in a database within computer 18. Computer 18 is then configured to print the screening result onto a paper medium which is retrieved by the passenger to be conveyed to another security station. In the exemplary embodiment, computer 18 is configured to transmit the identity of the passenger and the screening result to printer 252. When the screening process is completed, printer 252 is configured to print the screening result, the identity or name of the passenger being screened, and a date/time stamp is printed onto the paper medium to be retrieved by the passenger. Optionally, any other desired security related information may also be printed onto the paper medium. In the exemplary embodiment, the screening result is printed in an encoded format onto the paper medium such that the passenger being screened is unable to determine the result of the screening process. Optionally, the screening result is not encoded on the paper medium.

In another embodiment, the identity or name of the passenger being screened, and a date/time stamp is printed onto the paper medium. The paper medium is then conveyed by the passenger to another security station. Moreover, rather than printing the screening result onto the paper medium, the screening result is electronically transmitted to another security station, such that when a passenger arrives at the security station, the passenger presents the paper medium including the identification information to security personnel who then retrieve the electronically transmitted screening result to continue processing the passenger.

In another exemplary embodiment, means 250 is implemented utilizing a wireless technology. For example, the screening results and identity verification results are electronically transmitted from kiosk 22 to a security station associated with the kiosk 22, or are electronically transmitted to a portable device that is hand carried by the passenger to the security station.

Described herein before is a kiosk configured to optimize passenger movement through an airport terminal, and moreover, to assign a threat level indication to each passenger and associate the threat level indication with the specific passenger to facilitate reducing the time required to perform passenger identification and the various screening for both metal detection and explosives and/or contraband detection.

As such, the kiosk includes a modality utilized to perform explosives and or drug detection, a second modality that is utilized to perform metal detection, a third modality that is utilized to verify the identity of the passenger, and a means to associate the results of the security screening process to the passenger being screened.

Specifically, the kiosk described herein is utilized to enhance passenger movement through a screening portion of a travel terminal, such as for example, an airport terminal. To accomplish this, a passenger is screened utilizing system 10. The results of the screening are stored within computer 18. Moreover, a threat level indication is assigned to each passenger. The passenger's identity and the threat level indication are then delivered or associated to the passenger to allow the passenger to hand carry the results to the next security station. Optionally, the results are electronically transmitted to the next security station.

In the exemplary embodiment, the results of the screening are printed and onto a paper medium utilizing a printer device within kiosk 22 and date/time stamped to reflect the date and time the screening process was completed by the passenger. The passenger then retrieves the paper medium with the printed results and hand carries the paper medium to the next security station wherein the results are observed by security personnel and additional screening procedures are implemented based on the screening results. In the exemplary embodiment, the results, including the threat level indication are encoded such that a passenger is unaware of the threat level assigned based on the screening process.

The system described herein facilitates improving passenger flow through a security station within a travel terminal. Specifically, the system automatically assigns a threat level to a passenger being screened and associated this result with the passenger utilizing a printing device or an electronic transmitting means, for example. As such, the passenger being screening may obtain the results of the screening process themselves, thus eliminating the requirement of security personnel monitoring each screening station. Moreover, since the screening results may be encoded, the security personnel at subsequent security stations may be alerted of a potential security without allowing the passenger to be aware of the possible security violation. As a result, more travelers may be screened in a reduced amount of time to further improve travel efficiency. Moreover, the system described herein is highly reliable. As a result, the detection of contraband and other possible dangerous devices is increased, while reducing the overall time required to detect the same items.

While the invention has been described in terms of various specific embodiments, those skilled in the art will recognize that the invention can be practiced with modification within the spirit and scope of the claims.

What is claimed is:

1. A method of operating a passenger screening kiosk system; said method comprising:
conducting a screening process that includes at least one of verify a passenger's identity, detect the presence of an explosive material, and detect the presence of a metallic material;
generating a screening result from the conducted screening process; and
associating the screening result with the passenger.

2. A method in accordance with claim 1 wherein said generating a screening result comprises:
generating a threat level indication based on the screening result; and
associating the threat level indication with the passenger's identity.

3. A method in accordance with claim 2 wherein generating a threat level indication comprises generating at least one of a clearance indication, an identity alert indication, a threat alert indication, and an alarm indication.

4. A method in accordance with claim 1 wherein generating a screening result comprises:
generating a threat level indication based on the screening result; and
storing the threat level indication in the computer database.

5. A method in accordance with claim 1 wherein associating the screening result comprises communicating the screening result to a security station.

6. A method in accordance with claim 5 wherein communicating the screening result comprises electronically transmitting the screening result to a security station.

7. A method in accordance with claim 5 wherein the passenger screening kiosk system includes a printer, said communicating the screening result of the screening process comprises:
printing the screening result onto a paper medium such that the passenger being screened is enabled to convey the screening result to a security station.

8. A method in accordance with claim 7 wherein printing the screening result further comprises printing the screening result in an encoded format onto the paper medium.

9. A method in accordance with claim 8 further comprising:
time stamping the screening result; and
printing the time stamped screening result onto the paper medium.

10. A passenger screening kiosk system comprising:
an identity verification system;
a metal detection system;
an explosives detection system; and
a computer coupled to said identity verification system, said metal detection system, and said explosives detection system, said computer configured to
conduct at least one of verify a passenger's identity, detect the presence of an explosive material, and detect the presence of a metallic material;
generate a screening result of the screening process; and
associate the screening result with the passenger.

11. A passenger screening kiosk system in accordance with claim 10 wherein said computer is further configured to:
generate a threat level indication based on the screening result; and
associate the threat level indication with the passenger's identity.

12. A passenger screening kiosk system in accordance with claim 11 wherein to generate a threat level indication, said computer is further configured to generate at least one of a clearance indication, an identity alert indication, a threat alert indication, and an alarm indication.

13. A passenger screening kiosk system in accordance with claim 10 wherein said computer is further configured to:
generate a threat level indication based on the screening result; and
store the threat level indication in the computer database.

14. A passenger screening kiosk system in accordance with claim 10 further comprising a means to associate the screening result with the passenger, said computer further configured to activate said means to communicate the screening result to a security station.

15. A passenger screening kiosk system in accordance with claim 14 wherein said means comprise a wireless device configured to communicate the screening result to a security station.

16. A passenger screening kiosk system in accordance with claim 14 wherein said means comprise a printer configured to print the screening result onto a paper medium.

17. A passenger screening kiosk system in accordance with claim 16 wherein said means comprise a printer configured to print the screening result onto a paper medium in an encoded format.

18. A passenger screening kiosk system in accordance with claim 16 wherein said means comprise a printer configured to print a time and date stamp onto the paper medium.

19. A passenger screening kiosk system in accordance with claim 10 wherein said explosives detection system comprises a trace explosive fingertip scanner, said computer is further configured to prompt a passenger to position a finger on the trace explosive fingertip scanner and determine that the finger is positioned on the trace explosive fingertip scanner.

20. A passenger screening kiosk system in accordance with claim 10 wherein said explosives detection system comprises a quadrupole resonance detection system.

21. A passenger screening kiosk system in accordance with claim 10 wherein said identity verification system comprises a fingerprint scan device.

22. A passenger screening kiosk system in accordance with claim 10 wherein said identity verification system comprises an iris scan device.
